(19) United States
(12) Patent Application Publication
(10) Pub. No.: US 2022/0022483 A1
(43) Pub. Date: Jan. 27, 2022

(54) DEVICE FOR PREPARING A FROZEN FOOD PRODUCT FROM A LIQUID MIXTURE

(71) Applicant: Frederik Van Isacker, Zaventem (BE)

(72) Inventor: Frederik Van Isacker, Zaventem (BE)

(73) Assignee: KEMPISCHE BRIK CENTRALE, Zaventem (BE)

(21) Appl. No.: 17/021,767

(22) Filed: Sep. 15, 2020

Related U.S. Application Data
(63) Continuation of application No. PCT/EP2020/070863, filed on Jul. 23, 2020.

(51) Int. Cl. A23G 9/12; A23G 9/22

(52) U.S. Cl. CPC A23G 9/12; A23G 9/224; A23G 9/228

(57) ABSTRACT

A device is provided for preparing a frozen food product from a liquid mixture wherein the failure to correctly mix the liquid mixture is alleviated. The device includes a cup holder, a cooling unit, and a stirring unit having a stirring element, a motor, and a coupling element configured for releasably coupling the stirring element to the motor. The coupling element includes a fixed part and a translating part, wherein the fixed part includes a proximity sensor arranged to detect the distance of the translating part relative to the fixed part to generate an activation signal when the distance is below a predetermined proximity threshold.

### TECHNICAL FIELD

The present disclosure relates to a device for preparing a frozen food product, such as for example ice cream or sorbet, from a liquid mixture, as well as to the use of such a device.

### BACKGROUND

Devices for preparing a frozen food product, such as for example ice cream or sorbet, from a liquid mixture, are known in the prior art. The patent publication WO2015169841 A1 discloses such a device. The device comprises the following elements:

a cup holder comprising a cavity configured for releasably receiving a cup in which the frozen food product is to be prepared from the liquid mixture,

a cooling unit configured for cooling the cavity of the cup holder; and

a stirring unit comprising
a stirring element configured for stirring with a stirring motion the liquid mixture in the cup for preparing the frozen food product,
a drive system configured for driving the stirring motion of the stirring element in the cup, wherein the drive system comprises a motor and a coupling element configured for releasably coupling the stirring element to the motor,

wherein the coupling element comprises
a fixed part provided at a fixed position relative to the motor, and
a moveable part moveably arranged relative to the fixed part, wherein the moveable part comprises a rotor part arranged during an operational phase to rotate with respect to the fixed part, and wherein the rotor part comprises coupling means to releasably couple with the stirring element.

A problem with the device from WO2015169841, as well as with other devices from the prior art, is that often the stirring element is inadequately attached to the coupling means of the stirring unit, or that the user forgets to attach the stirring element to the coupling means of the stirring unit, prior to starting the operational phase, i.e. prior to the activation of the cooling unit and/or the motor of the stirring unit by pressing a start button on the device. As a consequence, the liquid mixture is often inadequately mixed. Furthermore, this has as a consequence that the stirring element often does not scrape the ice crystals that form on the walls of the cooled cup, thereby alleviating the further cooling of the liquid mixture.

### SUMMARY

It is an aim of the present disclosure to provide a device for preparing a frozen food product, such as for example ice cream or sorbet, from a liquid mixture, wherein the problem from the prior art is solved, i.e. to provide a device wherein a correct mixing of the liquid mixture and a correct scraping of the ice crystals from the cup walls is obtained.

This aim, or others, is achieved according to the disclosure with a device showing the technical characteristics of the first claim. The device according to the present disclosure is a device comprising a cup holder comprising a cavity configured for releasably receiving a cup in which the frozen food product is to be prepared from the liquid mixture, a cooling unit configured for cooling the cavity of the cup holder; and a stirring unit, preferably positioned above the cavity of cup holder. The stirring unit comprises a stirring element configured for stirring with a stirring motion the liquid mixture in the cup for preparing the frozen food product and preferably also configured for scraping ice crystals from the walls of the cup, and a drive system configured for driving the stirring motion of the stirring element in the cup. The drive system comprises a motor, preferably an electromotor such as a stepper motor, a synchronous motor, an induction motor or a reluctance motor. The motor preferably comprises a stator, a rotor and an output shaft connected to the rotor. The drive system further comprises a coupling element. The coupling element is configured for releasably coupling the stirring element to the motor. The coupling element is preferably configured for transforming the rotational movement of the output shaft of the motor into the stirring motion of the stirring element. The coupling element comprises a fixed part preferably provided at a fixed position relative to the motor, in particular relative to the stator of the motor, and a moveable part moveably arranged relative to the fixed part. The moveable part comprises a rotor part arranged during an operational phase to rotate with respect to the fixed part and a translating part attached to the rotor part by a spring member such as to enable during an initialization phase the translation of the translating part with respect to the rotor part along a first translational axis and such as to follow during the operational phase the rotation of the rotor part. In some embodiments, the translation of the translating part with respect to the rotor part during the initialization phase results in the translation of the translating part with respect to the fixed part, for example because the rotor part is translationally fixed, i.e. not allowed to translate, with respect to the fixed part along the first translation axis. In some embodiments, the spring member comprises a spring such as a helical spring, an elastic material spring or a pneumatic spring. The translating part furthermore comprises coupling means to releasably couple with the stirring element. The fixed part comprises a proximity sensor arranged to detect the distance of the translating part relative to the fixed part, in particular relative to the proximity sensor, along the first translational axis and to generate an activation signal when the distance is below a predetermined proximity threshold.

It has been found that the device of the present disclosure is not subjected to the problems of the prior art during the operational phase i.e. during the activation of the cooling unit and/or the motor of the stirring unit after pressing the start button on the device, because the device of the present disclosure comprises an initialisation phase prior to the operational phase, wherein the initialization phase guarantees a correct coupling of the stirring element to the coupling element. In particular, in the device of the present disclosure, the operational phase is only started after an activation signal has been generated, indicating that the stirring element applies a sufficient pressure to the cup walls to guarantee a correct mixing of the liquid mixture and to guarantee a correct scraping of the ice crystals being formed on the cup walls during the operational phase. Furthermore, the spring like arrangement of the translating part of the present disclosure allows to absorb distance variations between the stirring element and the cup walls and to thrust the stirring element against the cup walls.

According to an embodiment of the present disclosure, the translating part comprises magnetised means configured to generate a magnetic field. The magnetised means preferably are one or more permanent magnets. In some embodiments, the translating part is elongated and extends along the first translation means between opposite ends. In some embodiments, the magnetised means are provided at the end of the translating part that is most proximate to the fixed part, in particular that is most proximate to the proximity sensor provided on the fixed part, along the first translation axis. According to the embodiment, the proximity sensor is a Hall sensor configured to measure the magnetic flux created by the magnetic field, i.e. by the magnetic field generated by the magnetised means of the translating part. The Hall sensor is arranged to detect the distance of the translating part, in particular of the magnetised means on the translating part, relative to the fixed part, in particular relative to the hall sensor on the fixed part, along the first translational axis and to generate an activation signal when the distance is below a predetermined proximity threshold. It has been found that the present embodiment alleviates the need to provide electronic components on the translating part, which is a moving component, thereby making the device less prone to damage and making the assembling of the device less complex. The electronic component in the present embodiment is the Hall sensor which is provided on the fixed part, which is a non-moving part. Furthermore, it has been found that providing the magnetised means on the translating part, for example as opposed to on the stirring element, increases the durability of the device. Upon cleaning the device, the stirring element is removed from the drive system, and is separately cleaned in a washing machine. In case the magnetised means would have been provided on the stirring element, the magnetisation of the magnetised means would have rapidly deteriorated over time due to the increased temperatures to which the stirring element is subjected in the washing machine. Furthermore, it has been found that providing the magnetised means on the translating part, for example as opposed to on the stirring element, decreases the cost of the device, because the magnetised means are expensive components and because the stirring element has to be replaced more often than the translating part. Due to the scraping action of the stirring element against the cup walls, the stirring element is after all more prone to wear than the translating part, and thus requires a more frequent replacement. Furthermore, the stirring element is releasably attached to the remainder of the device, thereby increasing the risk that the stirring element would get lost and thus would need replacement.

According to an embodiment of the present disclosure, the operational phase is only started after the activation signal is generated. The start of the operational phase is for example controlled by a CPU (i.e. a ‘central processing unit’), which requires receipt of the activation signal, and optionally additional signals, in order to start the operational phase. In some embodiments, during the operational phase the cooling unit and the motor of the stirring unit are active. The cooling unit and the motor of the stirring unit for example receive instructions to start working from the CPU. During the operational phase the cooling unit for example cools the cavity of the cup holder according to a predetermined cooling program, and the motor of the stirring unit for example starts rotating, thereby imparting the stirring motion to the stirring element via the coupling element of the stirring unit. During the operational phase, the motor of the stirring unit can for example be instructed to rotate according to a driving program comprising different rotational speeds and/or torque levels as a function of time. According to an embodiment of the present disclosure, the operational phase is started after a start button on the device has been pressed and after the activation signal is generated. The start of the operational phase is for example controlled by the CPU, which requires receipt of the activation signal and of a signal generated upon pushing a start button on the device, in order to start the operational phase.

According to an embodiment of the present disclosure the stirring unit is moveably arranged relative to the cup holder, for example by moving at least the fixed part but preferably the entirety of the stirring unit, between on the one hand a loose position in which the stirring element does not contact the cup holder or, in use, the cup received in the cup holder, and on the other hand a contact position in which the stirring element contacts the cup holder or, in use, the cup received in the cup holder. In some embodiments, the stirring unit is further moveable when it is in the loose position, for example by moving at least the fixed part but preferably the entirety of the stirring unit, from a first loose position where the stirring element first comes loose from the cup holder or in use the cup received in the cup holder, up to an opened position in which the cavity of the cup holder is accessible for example enabling the placement or removal of a cup into the cavity. In some embodiments, the stirring unit is moveable by manual action, but can also be motorised. According to an implementation of the embodiment, the moveable arrangement of the stirring unit relative to the cup holder is a translational arrangement along a second translation axis. The second translational axis is preferably parallel to the gravitational acceleration vector, in particular when the device is in use. Alternatively, the moveable arrangement of the stirring unit relative to the cup holder is a rotational arrangement for example around an axis perpendicular to the first translation axis for example parallel to the ground level, and wherein the stirring unit is pivoted between the above mentioned positions. According to a further embodiment, when the stirring unit is in the contact position, the stirring element pushes the translating part towards the rotor part, and thus towards the fixed part, along the first translation axis. According to the embodiment, when the stirring unit is in the contact position, for example starting from the position of first contact i.e. the first contact position, the fixed part, and preferably the entire stirring unit apart from the stirring element and the translating part coupled to the stirring element, is further moveable, for example along the second translation axis, towards the cup holder up to a closed position in which the distance along the first translational axis between the fixed part, in particular the Hall sensor, and the translating part, in particular the magnetised means, is below the predetermined proximity threshold. In some embodiments, the steps of moving (the fixed part of) the stirring unit from the open position to the closed position is referred to as the initialization phase. The device transfers from the initialization phase into the operational phase if the conditions as previously described have been fulfilled. In case the device is not able to switch from the initialization phase to the operational phase, for example because the CPU expects an additional signal next to the activation signal, the device resides in a transition phase. According to an embodiment, the first translational axis is parallel to the second translational axis, for example when the device is in use parallel to the gravitational acceleration vector. This embodiment ensures that the translation of the (fixed part of the) stirring unit towards the cup holder and the translation of the stirring element towards the rotor part are aligned, thereby optimally allowing the stirring element to move towards the rotor part upon the stirring unit moving from the first contact position to the closed position.

According to an embodiment of the present disclosure, the device comprises multiple cup holders and corresponding stirring units. In a first implementation, a single cooling unit is provided wherein the single cooling unit comprises branched circuits towards the multiple cup holders. Each branched circuit is for example a valve-controlled branch comprising an evaporator for cooling the cavity of the corresponding cup holder. In this first implementation, major components of the cooling circuit such as the condenser and compressor are mutualised. In a second implementation, the device comprises multiple cooling units i.e. a cooling unit for each cup holder. According to the embodiment, the cooling unit only cools the cavity of the cup holder of which the corresponding stirring unit generates the activation signal. In the first implementation, this embodiment is preferably implemented by only opening the valves of the branches of the applicable cup holders. In some embodiments, the CPU controls the opening or closing of the valves of the branches associated with the cup holder of which it has received the activation signal. In the second implementation, this embodiment is preferably implemented by only activating the cooling unit of the applicable cup holder. In some embodiments, the CPI controls the activation of the cooling unit associated with the cup holder of which it has received the activation signal.

According to an embodiment of the present disclosure, the stirring element comprises an elongated rod. The elongated rod for example extends, for example in a substantially rectilinear manner, along an axis referred to as the elongation axis. The elongation axis is for example the symmetry axis of the elongated rod or of the stirring element in general. The elongated rod comprises coupling means complementary to the coupling means of the coupling element. The coupling means of the stirring element and the coupling element are for example respectively protrusions and slots or vice versa. The protrusions and slots for example together form a bayonet type lock configured to remain coupled upon rotation of the stirring element along a first rotational direction and configured to decouple upon rotation of the stirring element along the opposite rotational direction. In some embodiments, at least one stirring blade configured for, in use, stirring the liquid mixture and for contacting the cup, is connected, preferably integrally connected, to the elongated rod. In an embodiment the elongated rod is a hollow tube for example a cylindrical hollow tube.

According to an embodiment of the present disclosure, the stirring element, i.e. the assembly of the stirring rod and the stirring blade, is devoid of magnetization means. This reduces the costs of the stirring element. In some embodiments, the elongated rod of the stirring element, and preferably also the stirring blade of the stirring element, has a relative permeability of below 2. This reduces the amount of flux leakage from the magnetised means of the translating part.

According to an embodiment of the present disclosure, in use, the elongation axis is parallel to the first translational axis. This alignment ensures that the force exerted by the cup walls onto the stirring element when the stirring unit is in the contact position, is optimally transferred to the translating part, thereby optimally moving the translating part towards the rotor part and as a consequence towards the fixed part upon moving the (fixed part of the) stirring unit towards the cup holder.

According to an embodiment of the present disclosure, the stirring motion comprises a first rotation around a first rotational axis. The first rotational axis is preferably parallel to the gravitational vector when the device is in use. The first rotational axis is preferably parallel to the first translation axis. The first rotational axis is preferably coinciding with the elongation axis of the elongated rod. In a first embodiment, the stirring motion is not a planetary motion. In said first embodiment, the rotor part is arranged to be rotated along the first rotational and the translating part is arranged to be rotated along said first rotational axis because of the coupling between the rotor part and the translating part. In a second embodiment, the stirring motion is a planetary motion as explained next. In some embodiments, the stirring motion furthermore comprises a superposed second rotation around a second rotational axis, wherein the second rotational axis is not coinciding with the first rotational axis. The second rotational axis is preferably parallel to the gravitational vector when the device is in use. The second rotational axis is preferably parallel to the first translation axis such as to create a planetary stirring motion. The second rotational axis is preferably parallel to, but not coinciding with, the elongation axis of the elongated rod such as to create a planetary stirring motion. In said second embodiment, the rotor part is arranged to be rotated along the second rotational axis and the translating part is arranged to be rotated along the first rotational axis. The first rotational axis thereby being rotated along with the rotor part around the second rotational axis. In some embodiments, the coupling element comprises a planetary motion gear for transforming the rotation of the motor of the stirring unit into the planetary stirring motion, wherein the rotor part is a sun gear, the translating part is a planet gear, and the fixed part is a stationary ring gear. In some embodiments, the sun gear comprises a disc preferably connected to a shaft in a flanging manner, wherein the shaft preferably extends along the second rotational axis and wherein the shaft is preferably connected to the output shaft of the motor of the stirring unit. In some embodiments, the second rotational axis is provided substantially at the centre of the ring gear. In some embodiments, the disc of the sun gear is a toothless disc i.e. devoid of teeth configured to mesh with corresponding teeth on the planet or ring gear. In some embodiments, the planet gear extends through a borehole in the disc of the sun gear, thereby coupling during the operational phase the rotation along the second rotational axis of on the one hand the disc of the sun gear and on the other hand the planet gear i.e. such that both have the same number of rpm along the second rotational axis. The planet gear is preferably rotated along the second rotational axis either a) by meshing the teeth of the planet gear with teeth provided on the shaft of the sun gear, in which case the disc is coupled to the shaft of the sun gear in such a manner that rotation along the second rotational axis is allowed between them, or b) by following the rotation of the disc along the second rotational axis, in which case the shaft of the sun gear is coupled to the disc of the sun gear in such a manner that the disc is directly rotated by the shaft i.e. by not allowing rotation along the second rotational axis between them. In the latter implementation, the shaft of the sun gear is preferably devoid of teeth, because the advancement of the planet gear along the second rotational axis does not require meshing of the between the teeth of the shaft of the sun gear and the teeth of the planet gear. The planet gear is supported by the disc via the spring member such as to enable during an initialization phase the translation of the planet gear with respect to the sun gear along the first translational axis. The planet gear preferably comprises a gear part and a remaining part. The gear part of the planet gear comprises teeth for meshing with the teeth of the ring gear and optionally the shaft of the sun gear. The remaining part of the planet gear comprises an abutment surface whereon the spring member abut, and comprises the coupling means. The spring member furthermore supports the planet gear such as to allow during the operational phase the rotation of the planet gear along the first rotational axis for example by implementing the spring member as a spring provided with a bearing at one of its ends. The ring gear meshes with the planet gear such as to rotate the planet gear along the first rotational axis during the operational phase. The teeth of the ring gear are preferably extended along the first translational axis such as to allow translation of the planet gear with respect to the sun gear whilst maintaining a meshed contact between the ring gear and the planet gear.

According to an embodiment of the present disclosure, the translating part, when performing the second rotation, alternatingly passes a point most proximate to the proximity sensor and a most distally from the proximity sensor. According to an embodiment, the proximity sensor furthermore detects the passage of the translating part at the most proximate point. In a first application, the proximity sensor generates an RPM signal indicating the rotational speed of the translating part along the second rotational axis, for example indicating the number of rotations per minute that the translating part makes around the second rotational axis. In some embodiments, the RPM signal is fed back to the motor of the stirring unit in order to adjust the performance characteristics of the motor. In some embodiments, the RPM signal is fed back to the CPU, and the CPU instructs the motor of the stirring unit to adjust the performance characteristics. The performance characteristics of the motor are for example the rotational speed or torque of the motor of the stirring unit. In a second application, upon terminating the operational phase, the motor of the stirring unit rotates the moveable part along the second rotational axis such that the translating part is at a predetermined position, referred to as the start/stop position, relative to the most proximate point. The operational phase is terminated when the frozen product has been obtained. The determination of obtaining of the frozen product can be implemented in different manners, for example by monitoring a time limit or by monitoring the consistency of the liquid mixture for example by measuring the amount of torque exerted by the motor of the stirring unit. The start/stop position is preferably chosen such that the user has easy access to the stirring element when the stirring unit is in the open position, thereby enabling the easy removal and subsequent insertion of the stirring element into the coupling element. The start/stop position is preferably the position of the translating part closest to the user. In an embodiment, the device comprises a window occluding the access to the stirring element, and the start/stop position is a position adjacent to the window. In an embodiment the start/stop position is the position along the second rotation path that is furthest away from the compressor of the cooling unit. The start/stop position can be chosen by fixing the position of the proximate point and by storing the predetermined position with respect to the most proximate point, for example in a memory associated with the CPU. The most proximate point is fixed by the placement of the proximity sensor on the fixed part. In an embodiment the start/stop position is the position of the most proximate point. This embodiment makes it easier to detect the distance of the translating part with respect to the fixed part during the initialization phase, because in this embodiment the translating part will be closest to the proximity sensor during the initialization phase.

It is a further aim of the present disclosure to provide a use of the device as described above. The use of the device comprises sequentially performing the initialisation phase wherein the stirring unit is moved towards the cup holder such as to clamp the cup between the cup holder and the stirring element, and the operational wherein the cooling unit cools the cavity of the cup holder and wherein the motor of the stirring unit drives the stirring element according to the stirring motion.

### DESCRIPTION OF THE DRAWINGS

The disclosed subject matter will be further elucidated by the following description and the appended figures.

FIG. 1 shows a perspective overview of an embodiment of the device according to the present disclosure.

FIG. 2 is a cross-section of the device of FIG. 1 along the section AA, and shows a detailed view of the stirring unit and the cup received in the cup holder when the stirring element is removed from the stirring unit, and the stirring unit is in the open position.

FIG. 3 is a detailed view of part X in FIG. 2.

FIG. 4 is a cross-section of the device of FIG. 1 along the section AA, and shows a detailed view of the stirring unit and the cup received in the cup holder when the stirring element is coupled to the stirring unit, and wherein the stirring unit is in the closed position.

FIG. 5 is a detailed view of part X in FIG. 4.

### DETAILED DESCRIPTION

The present disclosure will be described with respect to particular embodiments and with reference to certain drawings but the disclosure is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the disclosure.

Furthermore, the terms first, second, third and the like in the description and in the claims, are used for distinguishing between similar elements and not necessarily for describing a sequential or chronological order. The terms are interchangeable under appropriate circumstances and the embodiments of the disclosure can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the disclosure described herein can operate in other orientations than described or illustrated herein.

The term “comprising”, used in the claims, should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present disclosure, the only relevant components of the device are A and B.

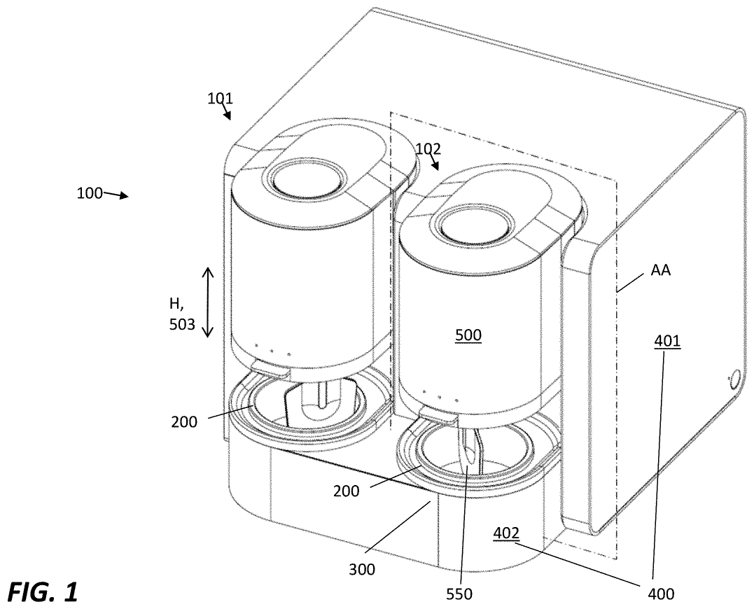

FIG. 1 shows a device 100 according to an embodiment of the present disclosure for preparing a frozen food product, such as for example ice cream or sorbet, from a liquid mixture. The device 100 comprises a first sub-unit 101 which is arranged for preparing a frozen food product in a first cup 200, and a second sub-unit 102 which is arranged for preparing a frozen food product in a second cup 200, different from the first cup 200. The first sub-unit 101 and the second sub-unit 102 are arranged in a similar manner and operate independent from each other, such that two cups 200 of frozen food product can be prepared separate from each other. In alternative embodiments, the device 100 may comprise only a single sub-unit 101, 102, or may be provided with more than two of the sub-units 101, 102. Since the first sub-unit 101 and the second sub-unit 102 are arranged in similar manner, the features of the device 100 will be discussed below only with respect to one of the sub-units 101, 102. The cup 200 comprises a cup wall which encloses a holding volume. The holding volume is arranged for holding the liquid mixture therein, and also for holding the frozen food product therein after the frozen food product has been prepared form the liquid mixture. At the top, the cup 200 comprises a top opening via which the holding volume can be accessed. The cup 200 may be pre-filled with the liquid mixture, whereby the top opening is sealed off by one or more sealing elements (not shown), such as a sealing membrane and a lid. The sealing elements can then be taken off the cup 200 before the cup 200 is to be used with the device 100. The cup 200 may also be a reusable cup 200, which is filled right with a liquid mixture from a package pre-filled with liquid mixture or with a self-made liquid mixture before the cup 200 is to be used with the device 100.

The device 100 comprises at its bottom a cup holder 300 which is arranged for holding the cup 200, preferably in a fixed position, while the frozen food product is being prepared in the cup 200. Therefore, the device 100 comprises a cavity in which the cup 200 can be received via an entrance opening.

The entrance opening of the cavity is located in a first upper surface of the cup holder 300.

The device 100 also comprises a cooling unit 400. The cooling unit 400 is arranged for cooling the cavity of the cup holder 300, and more specifically for cooling a cup 200 received in the cavity. The cooling unit 400 should be arranged to provide sufficient cooling for freezing liquid mixture contained in the cup 200 while preparing a frozen food product from the liquid mixture. The cooling unit 400 may comprise auxiliary components 401 such as one or more compressors, motors for driving the compressors, and condensers. The cooling unit 400 further comprises cooling pipes, which are arranged around each cavity such as to form one or more evaporators 402, and through which a cooling fluid is transported for cooling the cavities. The cooling unit 400 may however also be arranged in any other way know to the person skilled in the art for cooling the cavity of a device 100 for preparing a frozen food product from a liquid mixture.

The device 100 also comprises a stirring unit 500 which is arranged above the cup holder 300. The stirring unit 500 comprises a stirring element 550, and is configured for stirring the liquid mixture in the cup 200 by said stirring element 550 for preparing the frozen food product. The stirring element 550 is removably connectable to the stirring unit 500, such that the stirring element 550 can be taken out of the device 100 for cleaning.

The stirring unit 500 comprises a moveable portion which is moveable along a height direction H, further also referred to as the second translation direction 503 between a first position and a second position. In the first position, also referred to as the open position, the stirring element 550 is arranged outside of the cup 200, such that it is easily accessible for disconnecting it from the stirring unit 500 for cleaning and for connecting it to the stirring unit 500. In the second position, also referred to as the contact position, the stirring element 550 is arranged inside the cup 200 such that the stirring unit 500 can stir the liquid mixture in the cup 200 by the stirring element 550 for preparing the frozen food product.

The stirring unit 500 is also provided with a protection screen (not shown) which extends downwards from the stirring unit 500, and moves together with the stirring unit 500. When the of the stirring unit 500 is in the second position, the protection screen closes off an area located above the cup 200 and between the cup holder 300 and the stirring unit 500. This prevents access to the moving stirring element 550 when the frozen food product is being prepared, which is beneficial for safety. A further safety feature is that, in the second position of the stirring unit 500, the bottom edge of the protection screen supports on the upper surface of the cup holder 300, such that it is difficult to get underneath the protection screen and lift it up to gain access to the closed off area. The protection screen is also beneficial for the cleanliness of the device 100, since it contains spilled liquid mixture or frozen food product in the closed off area, and prevents it from further spreading over the device 100.

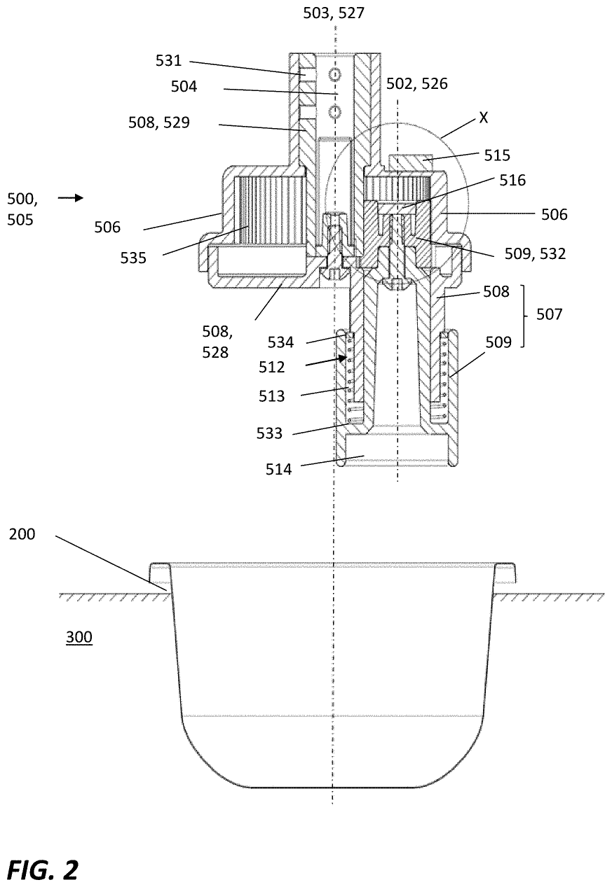

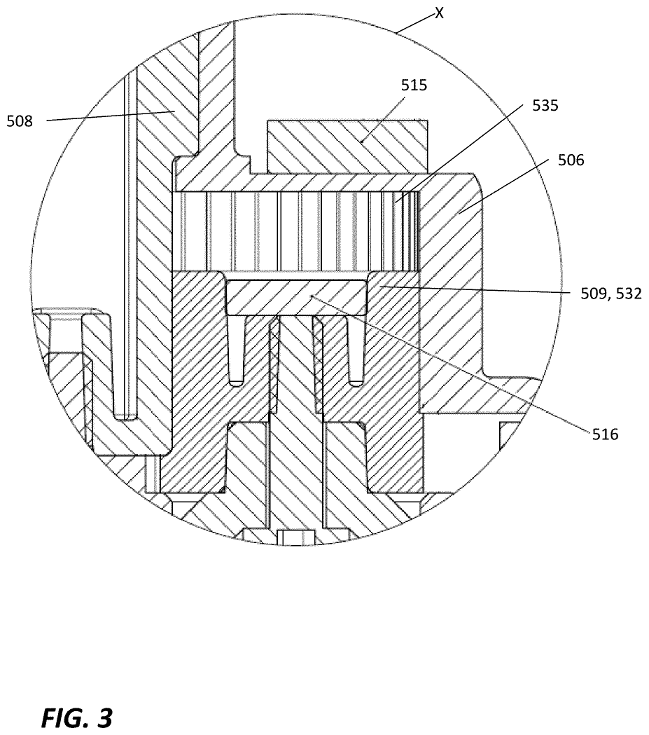

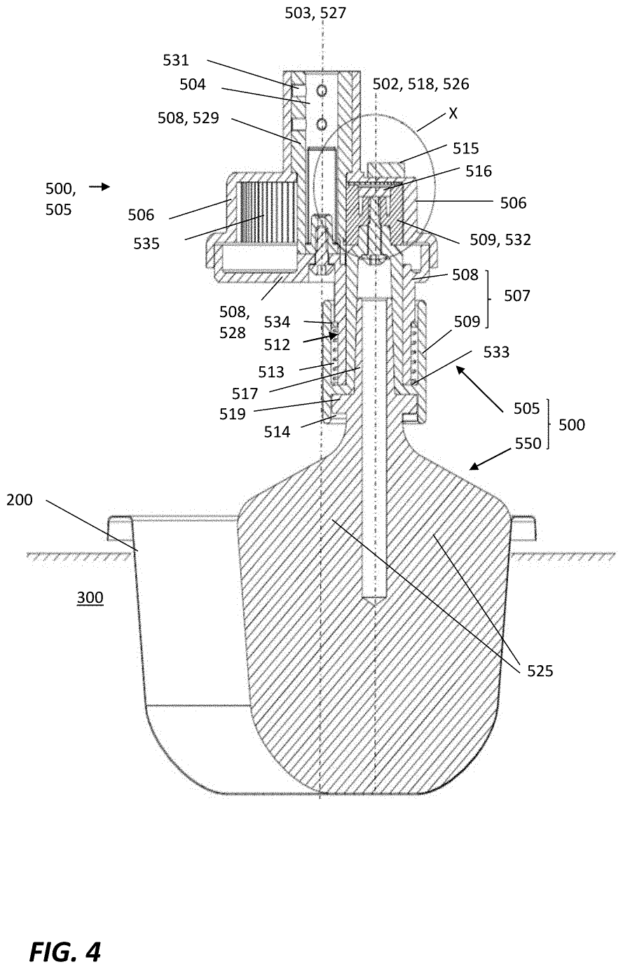

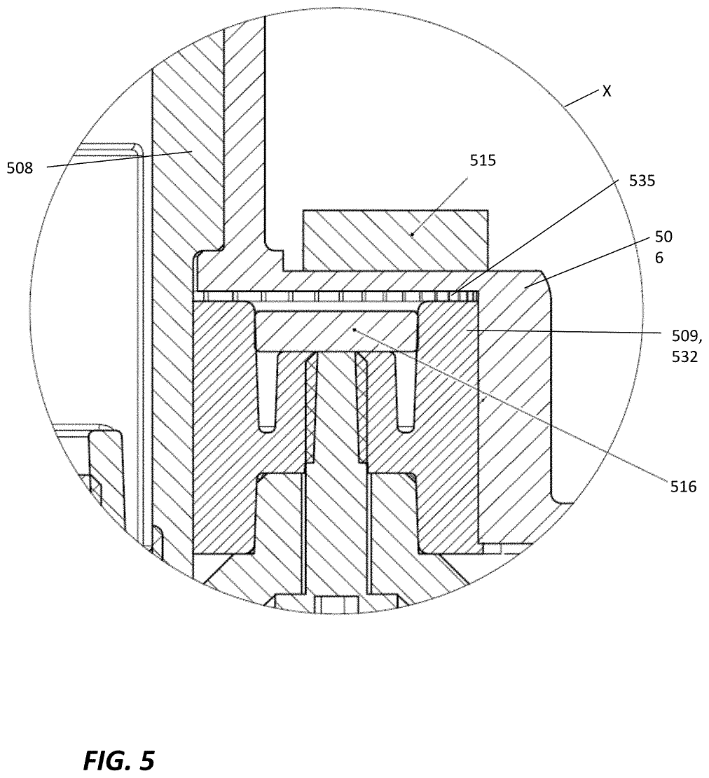

FIGS. 2 and 4 are cross-sections of the device of FIG. 1 along the section AA, and shows a detailed view of the stirring unit 500 and the cup 200 received in the cup holder 300. In FIG. 2 the stirring element 550 is removed from the stirring unit 500 and the stirring unit 500 is in the open position. In FIG. 4 the stirring element 550 is coupled to the stirring unit 500, and the stirring unit 500 is in the closed position. FIG. 3 is a detailed view of part X in FIG. 2. FIG. 5 is a detailed view of part X in FIG. 4.

FIGS. 2-5 show an embodiment of the device according to the present disclosure wherein for clarity reasons not every component is shown or is shown schematically. In the FIGS. 2-5 the device 100 is shown comprising a cup 200 received in the cavity of a cup holder 300 and a stirring unit 500 positioned above the cup holder 300. The stirring unit 500 comprises a stirring element 550 configured for stirring with a stirring motion the liquid mixture in the cup 200 for preparing the frozen food product and also configured for scraping ice crystals from the walls of the cup 200. The stirring unit 500 further comprises a drive system configured for driving the stirring motion of the stirring element 550 in the cup 200. The drive system comprises a motor (not shown), comprising a stator (not shown), a rotor (not shown) and an output shaft 504 connected to the rotor. The drive system further comprises a coupling element 505. The coupling element 505 is configured for releasably coupling the stirring element 550 to the motor. FIGS. 2 and 3 for example show the device 100 wherein the stirring element 550 is not coupled to the coupling element 505, and FIGS. 4 and 5 show the device 100 wherein the stirring element 550 is coupled to the coupling element 505. The coupling element 505 is configured for transforming the rotational movement of the output shaft 504 of the motor into the stirring motion of the stirring element 550. The coupling element 505 comprises a fixed part 506 provided at a fixed position relative to the stator of the motor, and a moveable part 507 moveably arranged relative to the fixed part 506. The drive shaft 504 of the motor of the stirring unit 500 extends through a bore in the fixed part 506. The moveable part 507 comprises a rotor part 508 arranged during an operational phase to rotate with respect to the fixed part 506 and a translating part 509 attached to the rotor part 508 by a spring member 512 such as to enable during an initialization phase the translation of the translating part 509 with respect to the rotor part 508 along a first translational axis 502 and such as to follow during the operational phase the rotation of the rotor part 508. The translation of the translating part 509 with respect to the rotor part 508 during the initialization phase results in the translation of the translating part 509 with respect to the fixed part 506, because the rotor part 508 is translationally fixed, i.e. not allowed to translate, with respect to the fixed part 506 along the first translation axis 502. The spring member 512 comprises a helical spring 513. The translating part 509 furthermore comprises coupling means 514 to releasably couple with the stirring element 550. The fixed part 506 comprises a proximity sensor 515 arranged to detect the distance of the translating part 509 relative to the fixed part 506 along the first translational axis 502 and to generate an activation signal when the distance is below a predetermined proximity threshold. The translating part 509 comprises magnetised means 516, i.e. magnets configured to generate a magnetic field. The magnetised means 516 are provided at the upper end of the translating part 509 because this upper end is most proximate to the fixed part 506, in particular most proximate to the proximity sensor 515 provided on the fixed part 506. The proximity sensor 515 is a Hall sensor configured to measure the magnetic flux created by the magnetic field, i.e. by the magnetic field generated by the magnetised means 516 of the translating part 509.

The stirring unit 500 is moveably arranged relative to the cup holder 300 between on the one hand a loose position in which the stirring element 550 does not contact the cup 200, in particular its bottom wall, received in the cup holder 300, and on the other hand a contact position in which the stirring element 550 contacts the cup 200, in particular its bottom wall, received in the cup holder 300. The moveable arrangement of the stirring unit 500 relative to the cup holder 300 is a translational arrangement along a second translation axis 503 parallel to the gravitational acceleration vector. The second translational axis 503 is parallel to the first translational axis 502. The stirring unit 500 is further moveable along the second translational axis 503, when it is in the loose position, from a first loose position where the stirring element 500 first comes loose from the cup 200, in particular its bottom wall, received in the cup holder 300, up to an opened position in which the cavity of the cup holder 300 is accessible for example enabling the placement or removal of a cup 200 into the cavity. FIGS. 2 and 3 show the stirring unit 500 in said loose position. As shown in FIGS. 4 and 5, when the stirring 500 unit is in the contact position, the stirring element 550 pushes the translating part 509 towards the rotor part 508, and thus towards the fixed part 506, along the first translation axis 502. When the stirring unit 500 is in the contact position, the fixed part 506, and more in particular the entire stirring unit 500 apart from the stirring element 550 and the translating part 509 coupled to the stirring element 550, is further moveable along the second translation axis 503, towards the cup holder 300 starting from the position of first contact i.e. the first contact position, up to a closed position in which the distance between the fixed part 506, in particular the Hall sensor 5015, and the translating part 509, in particular the magnetised means 5016, is below the predetermined proximity threshold. FIGS. 4 and 5 show the (fixed part 506 of) the stirring unit 550 in the closed position. The steps of moving (the fixed part 506 of) the stirring unit 550 from the open position to the closed position is referred to as the initialization phase.

As shown in the FIGS. 4 and 5, the stirring element 550 comprises an elongated rod 517. The elongated rod 517 is a hollow cylindrical tube extending along an axis referred to as the elongation axis 518. The elongation axis 518 is the symmetry axis of the elongated rod 517 and of the stirring element 550 in general. The elongated rod 517 comprises coupling means 519 complementary to the coupling means 514 of the coupling element 505. The coupling means 519 of the stirring element 550 and the coupling element 505 are respectively protrusions and slots. The protrusions and slots together form a bayonet type lock configured to remain coupled upon rotation of the stirring element 550 along a first rotational direction and configured to decouple upon rotation of the stirring element 550 along the opposite rotational direction. Two stirring blades 525 configured for, in use, stirring the liquid mixture and for contacting the cup 200, are integrally connected to the elongated rod 517.

The stirring motion comprises a first rotation around a first rotational axis 526. The first rotational axis 526 is parallel to the gravitational vector. The first rotational axis 526 is also parallel to the first translation axis 502. The first rotational axis 526 is more particularly coinciding with the elongation axis 518 of the elongated rod 517. The stirring motion furthermore comprises a superposed second rotation around a second rotational axis 527, wherein the second rotational axis 527 is not coinciding with the first rotational axis 526. The second rotational axis 527 is parallel to the gravitational vector. The second rotational axis 527 is also parallel to the first translation axis 502 such as to create a planetary stirring motion. The second rotational axis 527 is more particularly parallel to, but not coinciding with, the elongation axis 518 of the elongated rod 517 such as to create a planetary stirring motion. The coupling element 505 comprises a planetary motion gear 524 for transforming the rotation of the motor of the stirring unit 500 into the planetary stirring motion, wherein the rotor part 508 is a sun gear, the translating part 509 is a planet gear, and the fixed part 506 is a stationary ring gear. The sun gear 508 comprises a disc 528 connected to a shaft 529 in a flanging manner, wherein the shaft 529 extends along the second rotational axis 527 and wherein the shaft 529 is connected to the output shaft 504 of the motor of the stirring unit 500 via connection studs 531. The second rotational axis 527, and thus the shaft 529, is provided substantially at the centre of circle described by the teeth of the ring gear 506. The disc 528 of the sun gear 508 is a toothless disc i.e. devoid of teeth configured to mesh with corresponding teeth on the planet gear 509 or ring gear 506. The planet gear 509 extends through a borehole in the disc 528 of the sun gear 508, thereby coupling during the operational phase the rotation along the second rotational axis 527 of on the one hand the disc 528 of the sun gear 508 and on the other hand the planet gear 509 i.e. such that both have the same number of rpm along the second rotational axis 527. The planet gear 509 is rotated along the second rotational axis 527 by following the rotation of the disc 528 along the second rotational axis 527, i.e. the disc 528 drags the planet gear 509 along the second rotational axis 527. To that end the shaft 529 of the sun gear 508 is coupled to the disc 528 of the sun gear 508 in such a manner that the disc 528 is directly rotated by the shaft 529. The coupling between the disc 528 and the shaft 529 of the sun gear 508 in particular does not allow rotation along the second rotational axis 527 between them. The shaft 529 of the sun gear 508 is a toothless shaft, as it is not required to mesh with the teeth of the planet gear 509 in order to advance the planet gear 509 along the second rotational axis 527. The planet gear 509 is supported by the disc 528 via the spring member 512 such as to enable during an initialization phase the translation of the planet gear 509 with respect to the sun gear 508 along the first translational axis 502. The planet gear 509 comprises a gear part 532 and a remaining part. The gear part 532 of the planet gear 509 comprises teeth for meshing with the teeth of the ring gear 506. The upper part of the gear part 532 comprises the magnetised means 516. The remaining part of the planet gear comprises an abutment surface 533 whereon the spring member 512, in particular its helical spring 513, abuts, and comprises the coupling means 514. The spring member 512 furthermore supports the planet gear 509 such as to allow during the operational phase the rotation of the planet gear 509 along the first rotational axis 526 for example by implementing the spring member 512 as a spring 513 provided with a bearing 534 at its upper end. The teeth 535 of the ring gear 506 meshes with the planet gear 509 such as to rotate the planet gear 509 along the first rotational axis 526 during the operational phase. The teeth 535 of the ring gear 506 are extended along the first translational axis 502 such as to allow translation of the planet gear 509 with respect to the sun gear 508 whilst maintaining a meshed contact between the teeth 535 of the ring gear 506 and the teeth of the planet gear 509.

1. A device for preparing a frozen food product from a liquid mixture, the device comprising:
a cup holder comprising a cavity configured for releasably receiving a cup in which the frozen food product is to be prepared from the liquid mixture;
a cooling unit configured for cooling the cavity of the cup holder; and
a stirring unit, comprising:
a stirring element configured for stirring with a stirring motion the liquid mixture in the cup for preparing the frozen food product; and
a drive system configured for driving the stirring motion of the stirring element in the cup, wherein the drive system comprises a motor and a coupling element configured for releasably coupling the stirring element to the motor,
wherein the coupling element comprises:
a fixed part; and
a moveable part moveably arranged relative to the fixed part, wherein the moveable part comprises:
a rotor part arranged during an operational phase to rotate with respect to the fixed part, and
a translating part attached to the rotor part by a spring member such as to enable during an initialization phase the translation of the translating part with respect to the rotor part along a first translational axis and such as to follow during the operational phase the rotation of the rotor part, and wherein the translating part comprises coupling means to releasably couple with the stirring element,
wherein the fixed part comprises a proximity sensor arranged to detect a distance of the translating part relative to the fixed part along the first translational axis and to generate an activation signal when the distance is below a predetermined proximity threshold.

2. The device according to claim 1, wherein the translating part comprises a magnetic portion configured to generate a magnetic field, and wherein the proximity sensor is a Hall sensor configured to measure a magnetic flux created by the magnetic field.

3. The device according to claim 1, wherein the operational phase is started after the activation signal is generated, and wherein during the operational phase the cooling unit and the motor of the stirring unit are active.

4. The device according to claim 3, wherein the operational phase is started after a start button on the device has been pressed and after the activation signal is generated.

5. The device according to claim 1, wherein the stirring unit is moveably arranged relative to the cup holder between:
a loose position in which the stirring element does not contact the cup holder and, in use, the cup received in the cup holder; and
a contact position in which the stirring element contacts the cup holder and, in use, the cup received in the cup holder.

6. The device according to claim 5, wherein the stirring unit is moveably arranged relative to the cup holder in a translational arrangement along a second translation axis.

7. The device according to claim 6, wherein the first translational axis is parallel to the second translational axis.

8. The device according to claim 5, wherein when the stirring unit is in the contact position, the stirring element pushes the translating part towards the rotor part along the first translation axis.

9. The device according to claim 8, wherein when the stirring unit is in the contact position, the fixed part of the coupling element is further moveable towards the cup holder up to a closed position in which the distance along the first translation axis between the fixed part and the translating part is below the predetermined proximity threshold.

10. The device according to claim 1, wherein the stirring element comprises an elongated rod comprising coupling means complementary to the coupling means of the coupling element, and wherein at least one stirring blade configured for, in use, stirring the liquid mixture and for contacting the cup, is integrally connected to the elongated rod.

11. The device according to claim 10, wherein the elongated rod extends along an elongation axis, in use, parallel to the first translational axis.

12. The device according to claim 11, wherein the stirring motion comprises a first rotation around a first rotational axis coinciding with the elongation axis of the elongated rod.

13. The device according to claim 12, wherein the rotor part is arranged to be rotated along the first rotational axis.

14. The device according to claim 12, wherein the stirring motion further comprises a superposed second rotation around a second rotational axis, the second rotational axis being parallel to, but not coinciding with, the elongation axis of the elongated rod such as to create a planetary stirring motion.

15. The device according to claim 14, wherein the rotor part is arranged to be rotated along the second rotational axis and wherein the translating part is arranged to be rotated along the first rotational axis.

16. The device according to claim 15, wherein the coupling element comprises a planetary motion gear for transforming the rotation of the motor of the stirring unit into the planetary stirring motion, wherein the rotor part is a sun gear rotationally arranged around the second rotational axis, the translating part is a planet gear rotationally arranged around the first rotational axis, and the fixed part is a stationary ring gear.

17. The device according to claim 16, wherein:
the sun gear comprises a shaft extending along the second rotational axis and coupled to the motor of the stirring unit such as to rotate along the second rotational axis, and wherein the sun gear comprises a disc flanging with respect to the shaft,
the planet gear extends through a borehole in the disc of the sun gear such as to couple during the operational phase the rotation along the second rotational axis of on the one hand the disc of the sun gear and on the other hand the planet gear and wherein the planet gear is supported by the disc via the spring member such as to enable during an initialization phase translation of the planet gear with respect to the sun gear along the first translational axis, and such as to allow during the operational phase rotation of the planet gear along the first rotational axis, and
the ring gear meshes with the planet gear such as to rotate the planet gear along the first rotational axis during the operational phase, and wherein teeth of the ring gear are extended along the first translational axis such as to allow translation of the planet gear with respect to the sun gear whilst maintaining a meshed contact between the ring gear and the planet gear.

18. The device according to claim 14, wherein the translating part, when performing the superposed second rotation, alternatingly passes a point most proximate to the proximity sensor and most distally from the proximity sensor, and wherein the proximity sensor furthermore detects passage of the translating part at the most proximate point.

19. The device according to claim 18, wherein upon terminating the operational phase, the motor rotates the moveable part along the second rotational axis such that the translating part is at a predetermined position relative to the most proximate point.

20. A method of operating the device according to claim 1 wherein the device sequentially performs an initialization phase wherein the stirring unit is moved towards the cup holder such as to clamp the cup between the cup holder and the stirring element, and wherein in the operational phase, the cooling unit cools the cavity of the cup holder and the stirring unit drives the stirring element according to the stirring motion.
